(19) United States
(12) Patent Application Publication
(10) Pub. No.: US 2010/0175357 A1
(43) Pub. Date: Jul. 15, 2010

(54) ARRANGEMENT FOR HANDLING RECOVERED WASTE

(75) Inventor: Mauno Keski-Luopa, Lahti (FI)

Correspondence Address: YOUNG & THOMPSON, 209 Madison Street, Suite 500, Alexandria, VA, 22314, US

(73) Assignee: ACTIONECO OY, Lahti (FI)

(21) Appl. No.: 12/667,885

(22) PCT Filed: Jul. 7, 2008
(86) PCT No.: PCT/FI08/50418

§ 371 Date: Mar. 4, 2010

(30) Foreign Application Priority Data
Jul. 6, 2007 (FI) 20070536

(51) Int. Cl. A01D 43/063; A01D 43/06

(52) U.S. Cl. 56/203; 56/202

(57) ABSTRACT

A recovered waste processing arrangement is fitted in an independently movable power tool for maintaining the environment. The power tool includes at least one processing unit provided with a processing device. The processing unit is connected to the frame of the power tool. The arrangement includes: a chamber connected to the processing unit for receiving recovered waste from the processing device; a discharge aperture connected to the chamber; a transport duct, the first end of which is connected to a discharge aperture; a collecting tank connected to the power tool frame and to the second end of the transport duct; a first blower arranged between the processing unit chamber and the collecting tank, via which air and recovered waste carried along with air are sucked through the transport duct from the processing unit and blown into the collecting tank; and a second blower connected to the chamber by an air duct.

The invention relates to an arrangement for handling recovered waste according to the preamble of claim 1, suited in an independently movable power tool for maintaining the environment.

The invention also relates to a processing unit according to the preamble of claim 9, meant for an independently movable power tool for maintaining the environment.

In the prior art there is known, from the patent publication U.S. Pat. No. 6,082,086, an independently movable power tool that is a lawn mower apparatus. Said apparatus is provided with a number of reel-type cutting units and a connected arrangement for collecting grass clippings. Said collecting arrangement comprises a space arranged in connection with each cutting unit for receiving clippings from the cutter, a discharge aperture provided in said space, a number of first ducts or pipes, the first end of each duct being connected to the discharge aperture of one cutter, a duct connecting unit, to which the second ends of the first ducts are connected, a second duct, the first end of which is connected to the duct connecting unit, a blower unit that is arranged in the second duct and a grass catcher, to which the discharge aperture of the second duct is connected. Clippings are transported by the air flow created by the blower unit through the ducts from the cutter to the grass catcher.

The grass catcher is arranged in the top part of the body of the mower apparatus, on top of the engine hood behind the driver's seat. The problem is that the grass catcher is arranged at the other end of the vehicle body in relation to the cutting units. Now the ducts must be arranged over the cutters and along the sides of the body to the grass catcher. A fairly high efficiency is required of the blower unit in order to facilitate the transportation of the clippings from the cutting units to the grass catcher in general. In an embodiment of the invention, it is even suggested that for creating the air flow, there would only be used the cutting reels, but this is hardly possible, because the ducts are long and winding. Another problem is that the grass catcher and the ducts take up a lot of space around the device. This hinders the driver from sitting on the seat. In addition, the ducts partly cover the view of the driver, particularly as regards controlling of the cutting units.

The object of the invention is to eliminate the problems connected to the power tool described above, such as a cutting device, and to the collecting arrangement for recovered waste, particularly clipping waste, arranged in connection with said machinery. Another object of the invention is to realize a new processing arrangement for recovered waste, such as brushing waste and/or clippings or clipping waste.

The processing arrangement according to the invention is characterized by what is set forth in claim 1. The dependent claims 2-8 represent preferred embodiments of the invention.

The processing arrangement for recovered waste according to the invention is arranged in an independently movable power tool for maintaining the environment, the equipment of said power tool comprising at least one processing unit provided with a processing device, said processing unit being arranged in connection with the frame of the power tool, and said waste processing arrangement comprising: a chamber for receiving recovered waste from the processing device, said chamber being arranged in connection with the processing unit; a discharge aperture provided in connection with said chamber; a transport duct, the first end of which is connected to the discharge aperture; a collecting tank that is arranged in connection with the frame of the power tool, and to which the other end of the transport duct is connected; and a first blower that is arranged in between the processing unit chamber and the collecting tank, and by means of which air and recovered waste carried along with the air are sucked through the transport duct from the processing unit and blown further into the collecting tank.

According to the invention, the processing arrangement also comprises a second blower that is connected to the processing unit chamber by a supply air duct, and by means of which air is blown into the processing unit chamber for boosting the transportation of recovered waste.

An advantage of the invention is that by means of the first and second blowers, there is achieved an even mixing of air and recovered waste, such as brushing waste and/or clipping waste, in the processing unit chamber, and further an efficient transportation of the waste in particular from the processing unit to the collecting tank.

Another advantage of the invention is that the waste material fed in the chamber enters a powerful air circulation field, and hence does not easily stick to the chamber walls or the processing device.

Yet another advantage of the invention, particularly when the processing device is a cutter for cutting lawn or grass, is that the cutter blades remain sharp for a longer period of time. The cutter units of the processing unit are easy to keep clean. Because the blades are clean, they maintain their sharpness longer in use. Respectively, safety at work is improved, because the blades need not be cleaned manually. In addition, the rotary blades are better kept in balance, when they are not burdened by the clipping waste creating an imbalance that could cause vibration and possibly noise.

Another advantage of the invention, as regards the cutter units, is that a cut lawn remains cleaner owing to a more efficient collecting of waste.

Yet another advantage of the invention, as regards the cutter units, is that for moist clipping waste, an improved removal of the waste is better, because in that case the cutting unit or the blade is not blocked so easily.

In a preferred embodiment of the invention, the blowers are fitted in the transport duct, in the vicinity of the collecting tank, and also in the vicinity of the processing units; preferably the first blower, i.e. the discharge air blower, is connected directly to the collecting tank, and the second blower, i.e. the supply air blower, is connected to the processing units via the supply air ducts. It is pointed out that the combined air volume flow rate, realized by means of the blowers, is made remarkably larger than a volume flow rate generated by only one blower, i.e. only by a discharge air blower. A particular advantage in that the discharge air blower is fitted in the vicinity of the collecting tank is that the transport distance from the blower further to the tank is short, and thus the transport by air flow is very efficient. It is also pointed out that the duct from the discharge air blower to the collecting tank is most advantageously realized as a short pipe that is as straight as possible, so that the resistance caused by the duct for the air flow is minimized. Respectively, the inlet air ducts of the supply air blower are preferably ducts provided with fixed joints in between the blower and the processing unit, in which case various motions of the processing units, such as lifting and lowering motions, do neither affect the shape of the pipework nor add to the resistance of flow in the pipework.

In a preferred embodiment of the invention, the first and second blowers are realized as an integrated blower unit with two blowers.

In a preferred embodiment of the invention, the first and second blowers are driven by one and the same actuator, in which case the use of space is efficient, and there is only needed one power source for the blowers.

In a preferred embodiment of the invention, the first and second blowers are blowers arranged on the same axis. The employed power source is preferably an electric motor, connected either directly or through intermediation.

In a preferred embodiment of the invention, the first and second blowers are fitted in the same frame structure with the processing units, and they can be moved along with the processing units.

A processing unit according to the invention is characterized by what is set forth in claim 9. The dependent claims 10-14 represent preferred embodiments of the invention.

A processing unit according to the invention is meant for an independently movable power tool for maintaining the environment, said processing unit including a processing device that is fitted in connection with a chamber arranged for collecting waste, said chamber being provided with a discharge aperture, through which aperture waste should be removed from the chamber, and to which discharge aperture a discharge air blower is meant to be connected. According to the invention, the chamber is also provided with a supply air aperture for boosting waste removal; a supply air blower is meant to be connected to said aperture, and through said aperture, air is blasted to the chamber; further, clipping waste is meant to be removed from the chamber through said discharge aperture, by means of the air flow proceeding through the inlet aperture and the discharge aperture.

An advantage of a processing unit according to the invention is that it functions reliably, and that air and the waste transported along with the air are transferred from the processing unit chamber further to the collecting tank efficiently and without unnecessary losses and/or disturbances.

In the description below, the invention is described in more detail with reference to the appended drawings, where

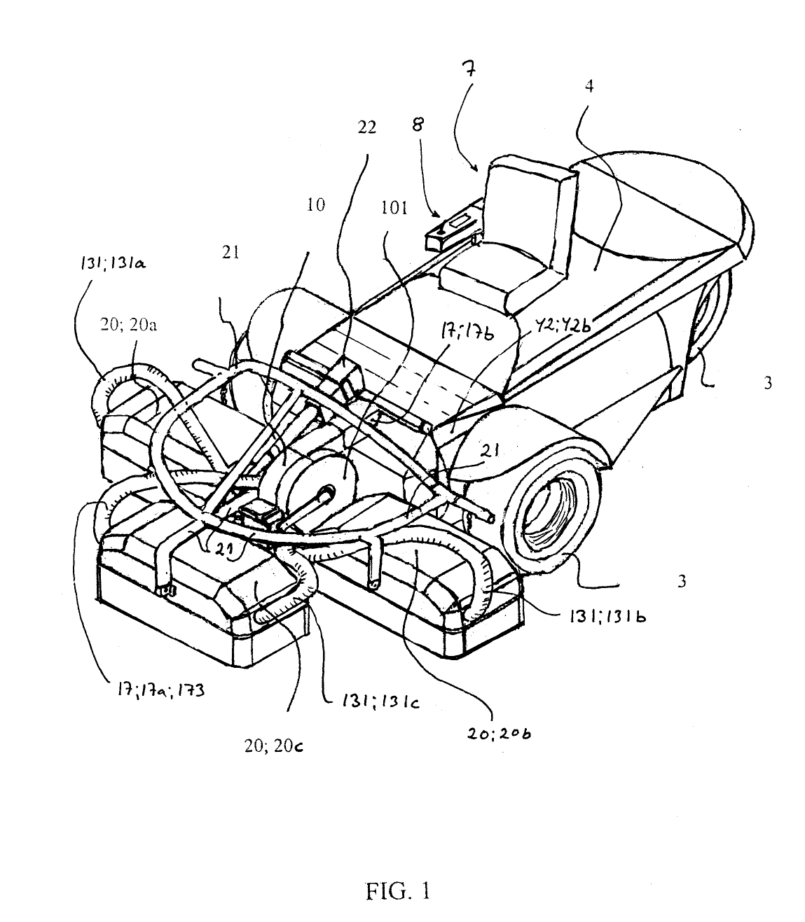

FIG. 1 is a perspective side view illustrating a power tool, seen from an inclined angle from above, said power tool being provided with a clipping waste processing arrangement according to the invention;

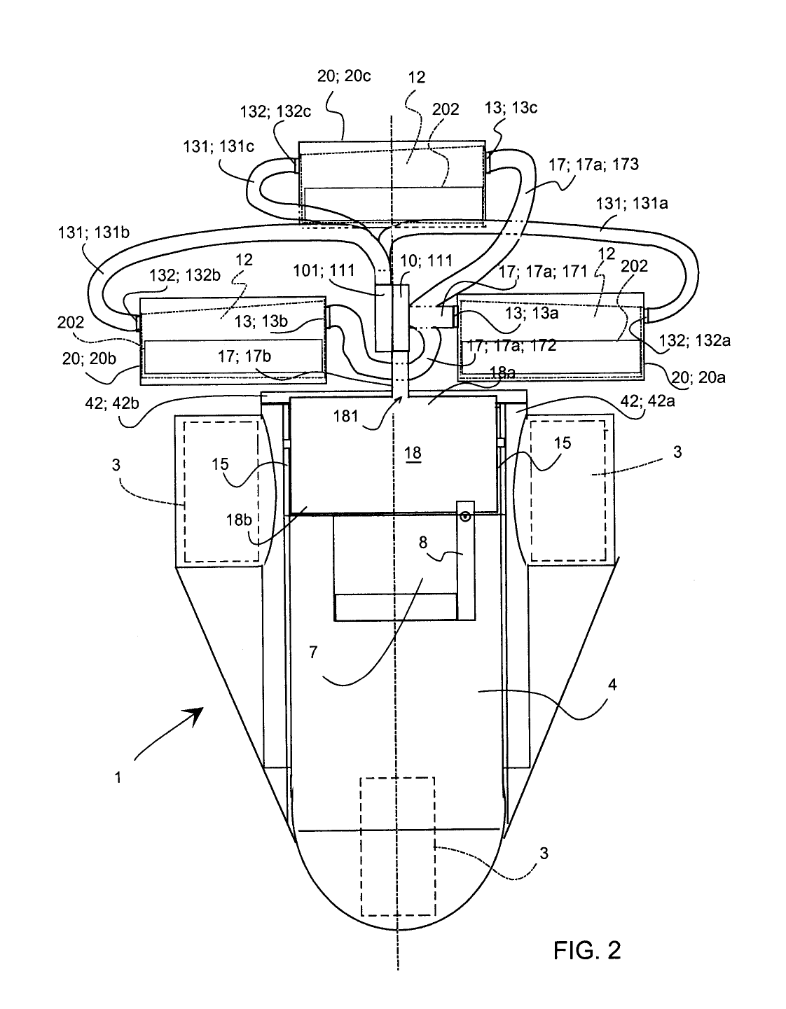

FIG. 2 is a top-view illustration of a power tool and clipping waste processing arrangement, seen in a partial cross-section, where the support frame of the processing unit is left out for the sake of illustration;

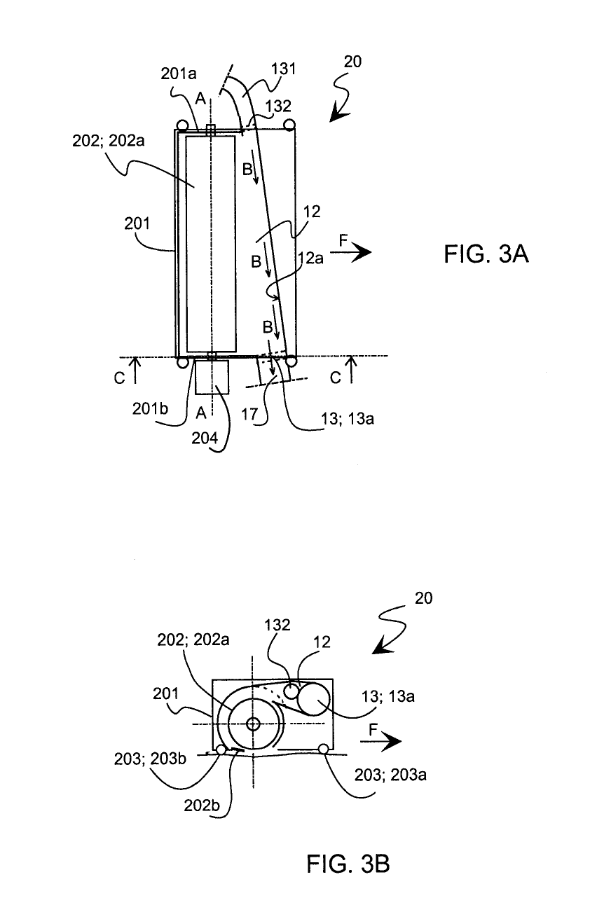

FIG. 3A is a schematical illustration of a processing unit, particularly a cutter unit, seen from above, in a partial cross-section along the horizontal level; and

FIG. 3B is a partial cross-section along the line C-C of said cutter unit;

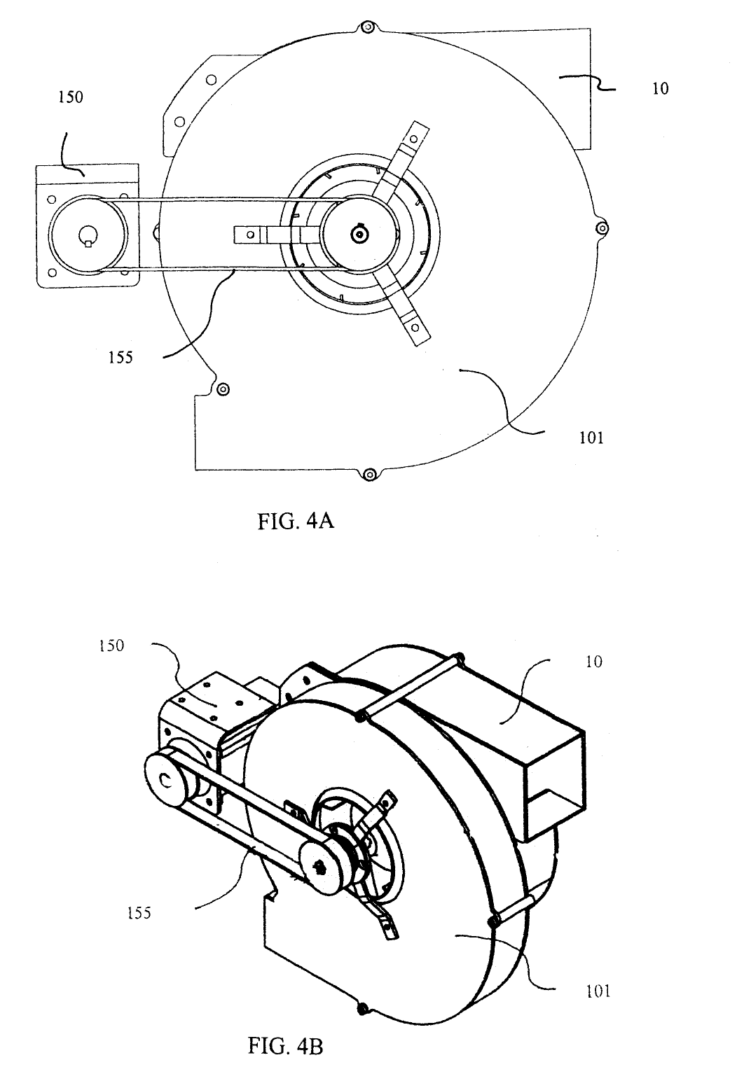

FIG. 4A is a side-view illustration of a double centrifugal blower that is driven by an electric motor and belt drive, and

FIG. 4B is a top-view illustration at an inclined angle of a double centrifugal blower that is driven by an electric motor and belt drive.

Like reference numbers for like parts are used in the drawings.

An independently movable power tool 1 is illustrated in FIGS. 1 and 2. The power tool is meant for maintenance, repair and/or cleaning work carried out primarily in courtyard areas or the like, but it can also be used in other corresponding tasks suitable for a light power tool. In connection with the power tool 1, particularly at the front part of its frame 4, there can advantageously be detachably attached various tools 2, preferably comprising one or several processing units 20 for realizing predetermined tasks. In this application, in connection with the power tool frame 4 there is fitted a seat 7 for the power tool user, and management and control means 8 for managing the power tool.

In the example according to the drawings, in connection with the power tool 1 there is fitted, as the processing unit 20, one or several cutter units 20a, 20b, 20c, by which the cutting of vegetation, particularly lawn or grass, should be carried out to a suitable height. This kind of combination of power tool and tools 2, i.e. cutting device for lawn or the like, shall be dealt with in more detail below.

Another advantageous example of processing units 20 to be fitted in connection with the power tool 1 is a brushing unit, by which a courtyard area or the like can be cleaned of garbage, vegetable waste, small quantities of sand or other soil material etc. It is pointed out that in structure, the cutter unit and the brushing unit to a great extent resemble each other. In the cutter unit 20, the employed processing device 202 is a rotary cutting blade and a fixed counterblade, whereas the brushing unit respectively includes a rotary brush and a fixed edge. In the specification below, especially the cutter unit and its connecting to the power tool shall be discussed in more detail, but also the brushing unit shall be referred to in suitable instances.

The power tool 1 comprises a frame 4 arranged on wheels 3. The power tool 1 is preferably provided with a number of drive motor units connected to the wheels 3 for moving said power tool. Each drive motor unit is provided with an electric motor. The operation of the drive motor units is adjusted by means of the control and management devices of the power tool 1. The power tool is provided with a battery set including a number of electrically connected batteries for obtaining electric energy for starting the drive motor units, among others. On the other hand, also some other power source than said electric motors can be used for moving and driving the power tool 1.

When the power tool 1 is realized as a mower of lawn or the like, at the end of the frame 4, in this case at the front end 42 thereof, there are arranged tools 2 for cutting the lawn. Said tools include a number of processing units 20, which in this case are cutter units 20a, 20b, 20c, altogether three in the device according to the drawings. Said processing units 20 are arranged preferably partly adjacently, but partly also in an overlapping manner and in succession, depending on the size of the device and on the number of the units, so that a stretch of the lawn that is as wide as possible can be cut in a uniform and even manner (or respectively an area in a courtyard or the like can be cleaned, when the processing unit is a brushing unit) when moving the power tool forward.

The processing units 20; 20a, 20b, 20c are attached to a support frame 21. At the end of the frame 4 of the power tool 1, particularly at its front end 42, there are arranged tool fastening devices, in connection with the processing units 20 can be detachably fastened by intermediation of the support frame 21. In addition, in between the front part 42 of the frame and the support frame 21, there also is provided a lifting/lowering device 22, by means of which the support frame 21 complete with the processing units can be shifted in between two extreme positions, i.e. the rest position and the working position. The lifting/lowering device 22 is preferably realized by means of one cylinder or, as an alternative, by means of two cylinders, particularly electrically operated cylinders. The lifting/lowering device 22 can be controlled by management and control means. Now the processing units 20 can be lowered down to the working position, for example for cutting lawn or for cleaning a courtyard, and respectively lifted up to the rest position, when the power tool 1 is for example driven to a lawn that needs cutting or away therefrom, or respectively to a courtyard area that needs brushing.

The processing unit 20 (cf. for example FIGS. 3A, 3B) comprises a processing device 202, such as a cutter for cutting lawn (or a brush for cleaning a courtyard) and support elements 203 for supporting the processing unit against the ground, particularly when cutting a lawn. The processing device 202, such as cutter, and the support elements 203, are arranged in connection with the frame 201.

In the drawings, the processing unit 20 is realized by means of a reel-type processing device, i.e. a processing reel 202, such as a reel cutter, i.e. a cutting reel 202a (or a brush reel, in the case of a brushing unit). The processing reel 202 comprises a cylindrical reel that is essentially rotary with respect to the horizontal axis A-A, in this case a cutting reel 202a and straight counterblade 202b (or a straight edge, in the case of a brush reel) arranged in the immediate vicinity thereof. The counterblade 202b is fitted in connection with the cutting reel 202a, underneath it. The cutting reel 202a is rotated by means of a suitable engine, preferably an electric motor 204.

The cutting reel 202a comprises, in a fashion known as such, a number of flat and in cross-section rectangular metal blades, arranged in a spiraling fashion on the surface area of a cylindrical housing, such as a reel, roller or the like, which blades are arranged to function together with the fixed, straight counterblade 202b, and to cut lawn, grass or corresponding low vegetation in a scissor-like manner, with an efficient cutting operation caused by the rotary motion. The distance of the counterblade 202b, and particularly of its cutting blade edge, from the ground defines the cutting height of grass or vegetation in general.

In the embodiment according to the drawings, the support elements 203 are realized by means of two support reels 203a, 203b, which are essentially parallel with the cutting reel 202a. The first support reel 203a is in the transfer direction of the cutter unit located in front of said unit, and the second support reel 203b is located behind it, so that the cutter 202 is left in between the support reels 203a, 203b. The cutter unit 20 is moved in a vertical direction F with respect to the cutting reel 202a of the cutter 202 and the counterblade 202b. The cutter unit 20 is supported against the ground by the support reels 203a, 203b when using the processing unit 20.

A recovered waste processing arrangement according to the invention is preferably fitted in a power tool 1 of the type described above, said arrangement including at least one processing unit 20, which is preferably provided with a reel-type cutter 202. As an alternative, the recovered waste processing arrangement is fitted in a power tool including at least one processing unit, where on a vertical axis, there is arranged a rotary propeller-like cutter, so-called plane cutter, rotating near the ground surface.

The processing arrangement for recovered waste, in this embodiment particularly clipping waste, comprises the following parts or elements: in the processing unit 20 a chamber 12 for receiving clipping waste (or corresponding brushing waste) from a cutter 202 (or a corresponding brush), in this case particularly from a cutting reel 202a (or a corresponding brush reel), a discharge aperture 13 and a supply air aperture 132 in connection with the chamber 12, a transport duct 17 and a collecting tank 18 in connection with the device frame; through said transport duct, clipping waste or respective recovered waste is transferred from the chamber to the collecting tank. The inlet aperture 132 of the chamber 12 of the processing unit 20 is arranged essentially on the opposite side of the chamber 12 with respect to the discharge aperture 13.

In addition, the processing arrangement comprises a first blower, i.e. a discharge air blower 10, and a second blower, i.e. a supply air blower 101. The discharge air blower 10 is arranged in the transport duct 17 located in between the processing unit chamber 12 and the collecting tank 18. The supply air blower 101 is connected, by a supply air duct 131, to the chamber 12 of one or several processing units, particularly to the supply air aperture 132 thereof.

The frame 4 of the power tool 1, particularly the front part 42 of the frame, is provided with a cavity 15 for the collecting tank 18 (cf. FIG. 2). The cavity 15 is placed in between the branches 42a, 42b of the front part 42 of the frame.

The inlet aperture 181 of the collecting tank 18 is arranged at the front part 18a of the collecting tank 18. The other end 172 of the transport duct 17 is connected to the inlet aperture 181 of the tank. The collecting tank 18 is also provided with an outlet for removing the recovered waste, such as clipping waste, from the tank.

Moreover, the collecting tank is provided with holes for removing the out flowing air, in order to prevent overpressure from being created in the collecting tank.

The processing unit 20 is provided with a chamber 12 for receiving clipping waste or the like from the processing device 202, particularly a processing reel 202a, and with a discharge aperture 13 and supply air aperture 132 arranged in connection with the chamber 12. As is apparent from FIGS. 3A and 3B, the chamber 12 is arranged in the processing unit 20 preferably on the level of the upper part of the reel 202a and on the front side thereof, when observed in the processing unit transfer direction F. This is the most advantageous location for the chamber 12 with respect to the reel 202a, because now the recovered waste obtains a relatively high initial speed towards the chamber 12 by means of the air flow created by the clockwise rotation of the cutting reel (or a corresponding brush reel). As an alternative, the chamber 12 can be arranged at least partly behind the reel 202a, when viewed from the transfer direction F, either completely or partly above the cutting reel.

The chamber 12 is elongate and it extends essentially along the width of the reel 202a. The chamber 12 is preferably designed so that the chamber 12 is, in its longitudinal direction and simultaneously in the direction A-A of the axis of the reel 202a, arranged to expand evenly (i.e. at least roughly conically) from the first end 121 towards the second end 122, and at the same time from the inlet aperture 132 towards the discharge aperture 13, said apertures being arranged at the chamber ends. The inlet aperture 132 is preferably arranged in connection with the first side wall 201a of the unit frame 201, and the discharge aperture 13 is preferably arranged in connection with the second side wall 201b of the processing unit frame 201.

The rear wall 12a of the chamber is designed so that it directs the clipping waste and air flow coming from the rotary cutting reel 202a and the inlet aperture 132 of the chamber 12 towards the discharge aperture 13. Now the rear wall 12a of the chamber 12 is in cross-section curved in the longitudinal direction of the cutting reel 202a, or at least placed at an inclined angle with respect to said longitudinal direction, so that the first edge of the wall is located near one end of the cutting reel, and the second edge of the wall is located further from the cutting reel, at the edge of the discharge aperture 13; 13a provided in the side wall 201b (cf. FIG. 3A). In that first edge of the cutter unit that is located nearer to the cutting reel, there is fitted a supply air aperture 132. Through said supply air aperture, there can be fed an air flow that is conducted along the supply air duct 131, said air flow being created by the supply air blower 101. The air flow conducted from the supply air aperture 132 to the chamber 12 is arranged to proceed along the rear wall 12a of the chamber (cf. arrows B, FIG. 3A), so that a moving air cushion is formed against the rear wall. The clipping waste or the like coming from the reel 202a along the air flow created by the rotation of the reel hits the moving air cushion that catches the clipping waste along and transports it to the discharge aperture 13 located at the opposite edge of the chamber 12. Thus the clipping waste or other corresponding waste does not get into contact with the walls of the chamber 12, but is mixed in the powerful air flow passing through the chamber inside the processing unit, and sucked through the discharge aperture 13 to the transport duct 17 and further to the collecting tank 18. All collected waste is conducted, after the treatment of the reel 202a of the processing unit 202, such as a cutting reel (or a brushing reel), to the waste-discharging circulation field washing the chamber 12 that is mainly created by the combined inlet and outlet flow generated by means of the supply air blower 10 and the discharge air blower 101.

The supply air aperture 132 of the processing unit chamber 12 is preferably smaller in cross-section than the discharge aperture 13.

In the cutting operation, the cutting is preferably carried out by a rotary blade, where the blade strips are typically spiraling. The rotary blade may include several blade strips. For a man skilled in the art, the cutter is typically known as a reel cutter or a cutting reel. The notion ‘cutting moment’ or ‘cutting operation’ refers to the moment when the rotary blade strip meets the counterblade, and the grass (leave of grass) possibly left in between the blades is cut, and the tip of the leave is flown into the restricted air space inside the cutting chamber. When speaking of the moment after the cutting moment or operation, we refer to the air space that is smaller than said cutting chamber and is (in the rotary direction) located after the blade strip and the counterblade. Said area (or space) can be 0-180 degrees in the rotary direction, from the contact point of the blade strip and counterblade.

The circulation field inside the processing unit can be mainly parallel with the section (i.e. the tangent) or transversal with respect to the section (i.e. placed in the axial direction), or preferably a combination of these directions. The direction of the circulation field inside the cutter unit can be controlled by means of the forms and orientations of the supply air aperture 132 and the discharge aperture 13. The chamber is expanding from the supply air aperture 132 towards the discharge aperture 13. In addition, the volume flow and pressure of the supply air and outlet air affect the properties of the circulation field. Moreover, the design, rotary speed and rotary direction of the cutting reel of the processing unit affect the circulation field. When rotating, the cutting reel also creates an air flow in the direction of the axis A-A. In the cutting reel, the curvature and/or rotary direction of the spirals can be chosen so that said flow created by the cutter is preferably parallel with the circulations created by the supply air and discharge air blows.

The inlet air is generated by the other blower, i.e. the supply air blower 101, advantageously a centrifugal blower, that is located at the first end of the supply air duct 131. The air flow generated by the supply air blower 101 is conducted along the supply air duct 131 to the supply air apertures 132 of the processing unit or units. The supply air duct 131 is advantageously branching, in which case each processing unit 20; 20a, 20b, 20c has its own supply air duct element 131a, 131b, 131c. The supply air duct 131; 131a, 131b, 131c is advantageously realized of a ductile pipe that is preferably made of plastic.

The blowers 10, 101 are located near the processing unit or units 20 and the collecting tank 18, in which case the transfer distances of the air flow, as well as the resistances of flow, remain small. Both the blowers 10, 101 and the supply air duct 131 are advantageously fastened directly to the support frame 21. Now they move at the same time as the processing units 20 are shifted by intermediation of the support frame, typically in connection with a lifting or lowering operation.

In the processing arrangement for recovered waste, the chamber 12 consisting of one or several processing units 20; 20a, 20b, 20c for receiving waste is connected at its discharge aperture 13 and by intermediation of the transport duct 17 to the collecting tank 18. The device 1 according to the drawings includes several processing units 20; 20a, 20b, 20c, which are connected, each by a specific transport duct element 17; 171, 172, 173, directly to the inlet aperture 181 provided for said duct element in connection with the collecting tank 18. The transport duct elements 17; 171, 172, 173 are preferably realized of a ductile pipe that is preferably made of plastic.

The first blower, i.e. the discharge air blower 10, is fitted in the transport duct 17. In addition, the discharge air blower 10 is arranged in the vicinity of the collecting tank 18, either directly in connection with the collecting tank 18 and its inlet aperture 181, or, as an alternative, at a short distance from it. The discharge air blower 10 comprises for example a centrifugal blower. The suction inlet of the discharge air blower 10 is connected to the discharge aperture 13 of the chamber 12 of the processing unit 20 by a first transport duct element 17a, and respectively the suction outlet is connected directly or by a second transport duct element 17b to the collecting tank 18.

In a preferred embodiment of the invention, the blower unit 111 comprises, as an integrated arrangement, both the supply air blower 101 and the discharge air blower 10. This is preferably fastened and supported against the support frame 21 of the processing unit 20. The transport duct 17; 17b from the discharge air blower 10 to the collecting tank is short, for example 30-50 cm. It moves between two positions, i.e. between the high and the low position, when the processing unit 20 is lifted and lowered by the lifting/lowering device 22. At the same time, the position of the collecting tank changes, as was already explained above.

The blower unit 111 comprises either two centrifugal blowers or preferably a double centrifugal blower, where preferably one and the same actuator is used for running the first and second blowers 10, 101. Thus there is obtained a sufficiently strong air flow, particularly in the connecting pipes from several different processing units. The discharge air blower 10 is meant for creating suction in the transport ducts 17 and the collecting tank 18. The supply air blower 101 is meant for generating supply air, i.e. an air blast, in the cutter unit/units 20. On the suction side, at the discharge aperture 13, the flow rate obtained by the blowers 10, 101 is for example about 30 m/s, and on the blast side, at the supply air aperture 13, it is for example about 40 m/s. The actuator of the blowers is preferably an electric motor 150 driven through a belt drive 155. The speed of rotation of both the blowers and cutters can be adjusted.

As regards the fastening joints of the supply air blower 101, it is preferably fitted adjacently with the discharge air blower 10. Both blowers can preferably, but not necessarily, be run by one and the same actuator. For conducting air, the supply air blower 101 is at the outlet connected to the supply air duct 131, which is after the supply air blower arranged to be divided into branches, so that for each processing unit 20, there is conducted a specific connecting duct 131a, 131b, 131c to the supply air aperture 132. The supply air duct 131 is preferably made of a solid but ductile pipe that can move along with the lifting/lowering device 22.

The discharge air blower 10 is preferably provided with straight ailerons, in order to prevent the clipping waste carried along with the air flow from sticking too easily inside the blower. The ailerons of the supply air blower 101 are preferably curved, in order to achieve a higher blowing power in the processing unit chamber 12.

In a preferred embodiment of the invention, the blowers 10 and 101 are fitted in the transport duct 17, in the central region of the pattern, such as a triangle, formed by the processing units 20. Now the device is viewed from above.

The electric motor (or separate electric motors) 150 of the supply air blower 101 and of the discharge air blowers 10 can be automatically switched on and off, in connection with starting and ending a working step, such as cutting lawn or brushing, at the same time as the operation of the processing units is started/ended. The blowers can also be controlled automatically with delay periods in connection with starting/ending a working step. Naturally the blowers 10,101 can also be controlled manually.

Let us point out that for a man skilled in the art, it is obvious that the blowers 10,101 and the ducts for generating and conducting air flows can be realized in many different ways. A few preferred embodiments for realizing the actuator device are described in the specification above.

The invention is not restricted to the above described preferred embodiment only, but many modifications are possible within the scope of the inventive idea defined in the appended claims.

1. A recovered waste processing arrangement that is fitted in an independently moved power tool (1) for maintaining the environment, the tools (2) of said power tool comprising at least one processing unit (20; 20a, 20b, 20c), provided with a processing device (202), said processing unit being arranged in connection with the frame (4) of the power tool, and said recovered waste processing arrangement comprising:
a chamber (12) for receiving recovered waste from the processing device (202), said chamber (12) being arranged in connection with the processing unit (20);
a discharge aperture (13) arranged in connection with the chamber (12);
a transport duct (17), the first end whereof is connected to the discharge aperture (13);
a collecting tank (18) that is arranged in connection with the power tool frame (4), to which tank the other end of the transport duct (17) is connected; and
a first blower (10) that is arranged in between the processing unit chamber (12) and the collecting tank (18), by means of which blower, air and recovered waste along with the air are sucked through the transport duct (17) from the processing unit and blown into the collecting tank (18),
characterized in that the processing arrangement also comprises
a second blower (101) that is connected to the chamber (12) of the processing unit by a supply air duct (131), by means of which blower, air is blown to the chamber (12) of the processing unit (20) for boosting the transfer of the clipping waste.

2. A recovered waste processing arrangement according to claim 1, characterized in that the inlet aperture (132) of the chamber (12) of the processing unit (20), to which a supply air duct (131) is connected, is arranged essentially on the opposite side of the chamber (12) with respect to the discharge aperture (13), said discharge aperture being connected to a transport duct (17).

3. A recovered waste processing arrangement according to claim 1, characterized in that
the processing unit (20) comprises, as the processing device (202), a processing reel (202a), and that the chamber (12) is elongate and extends essentially along the whole width of the processing reel (202a); said chamber (12) is in the lengthwise direction and simultaneously in the direction (A-A) of the axis of the reel (202a) arranged to broaden evenly from the first end (121) towards the second end (122), and at the same time from the inlet aperture (132) towards the discharge aperture (13), which apertures are arranged at the chamber ends.

4. A recovered waste processing arrangement according to claim 3, characterized in that the chamber (12) is arranged in the processing unit (20) on the level of the upper part of the processing reel (202a), and on the front side thereof, when viewed from the transport direction (F) of the processing unit.

5. A recovered waste processing arrangement according to claim 1, characterized in that the processing arrangement comprises a blower unit (111), where a first and second blower (10, 101) are interconnected, and they are run by one single actuator.

6. A recovered waste processing arrangement according to claim 1, characterized in that the blowers (10, 101) are functionally connected to the processing unit support frame (21).

7. A recovered waste processing arrangement according to claim 1, characterized in that the blowers (10, 101) are centrifugal blowers.

8. A recovered waste processing arrangement according to claim 1, characterized in that the processing device (202) of the processing unit (20) is alternatively a cutter, preferably a cutting reel, or a brush, preferably a brushing reel.

9. A processing unit (20) that is meant for an independently movable power tool (1) for maintaining the environment, said processing unit including a processing device (202) that is fitted in connection with a chamber (12) designed for collecting waste, said chamber being provided with a discharge aperture (13), through which aperture waste is removed from the chamber, and to which aperture there is connected a discharge air blower, characterized in that the chamber (12) also is provided with a supply air aperture (132) for boosting waste discharge, that a supply air blower is connected to said aperture, and that through said aperture, air is blown into the chamber; through said discharge aperture (13), recovered waste is removed from the chamber (12) by means of an air flow proceeding through the inlet aperture and the discharge aperture.

10. A processing unit according to claim 9, characterized in that the inlet aperture (132) of the chamber (12) of the processing unit (20), to which aperture there is connected a supply air duct (131), is arranged essentially on the opposite side of the chamber (12) with respect to the discharge aperture (13).

11. A processing unit according to claim 9, characterized in that the processing device (202) of the processing unit (20) is a processing reel (202a), and that the chamber (12) is elongate and extends essentially along the whole width of the processing reel (202a), which chamber (12) in the lengthwise direction and simultaneously in the direction (A-A) of the axis of the reel (202a) is arranged to broaden evenly from the first end (121) towards the second end (122), and at the same time from the inlet aperture (132) towards the discharge aperture (13), said apertures being arranged at the chamber ends.

12. A processing unit according to claim 11, characterized in that the chamber (12) is arranged in the processing unit (20) on the level of the upper part of the processing reel (202a) and on the front side thereof, when observed from the transfer direction (F) of the processing unit.

13. A processing unit according to claim 11, characterized in that the processing reel (202a) is a cutting reel.

14. A processing unit according to claim 11, characterized in that the processing reel (202a) is a brushing reel.

15. A processing unit according to claim 10, characterized in that the processing device (202) of the processing unit (20) is a processing reel (202a), and that the chamber (12) is elongate and extends essentially along the whole width of the processing reel (202a), which chamber (12) in the lengthwise direction and simultaneously in the direction (A-A) of the axis of the reel (202a) is arranged to broaden evenly from the first end (121) towards the second end (122), and at the same time from the inlet aperture (132) towards the discharge aperture (13), said apertures being arranged at the chamber ends.

16. A processing unit according to claim 12, characterized in that the processing reel (202a) is a cutting reel.

17. A processing unit according to claim 12, characterized in that the processing reel (202a) is a brushing reel.

18. A recovered waste processing arrangement according to claim 2, characterized in that the processing unit (20) comprises, as the processing device (202), a processing reel (202a), and that the chamber (12) is elongate and extends essentially along the whole width of the processing reel (202a); said chamber (12) is in the lengthwise direction and simultaneously in the direction (A-A) of the axis of the reel (202a) arranged to broaden evenly from the first end (121) towards the second end (122), and at the same time from the inlet aperture (132) towards the discharge aperture (13), which apertures are arranged at the chamber ends.
